(19) United States
(12) Patent Application Publication
(10) Pub. No.: US 2013/0075379 A1
(43) Pub. Date: Mar. 28, 2013

(54) WELDING DEVICE

(71) Applicants: XIAO-GANG YIN, Shenzhen City (CN); GUO-YI CHEN, Shenzhen City (CN)

(72) Inventors: XIAO-GANG YIN, Shenzhen City (CN); GUO-YI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/287,137

(22) Filed: Nov. 2, 2011

(30) Foreign Application Priority Data
Sep. 27, 2011 (CN) 201120370970.2

(51) Int. Cl. B23K 9/00

(52) U.S. Cl. 219/136

(57) ABSTRACT

A welding device includes a base unit, a welding gun unit, and a smoke exhaust unit. The welding gun unit is electrically connected to the base unit to be turned on and off by operations on the base unit. The smoke exhaust unit is structurally connected to the base unit, and suctions smoke and dust generated by use of the welding gun unit and exhausts the smoke and dust via the base unit.

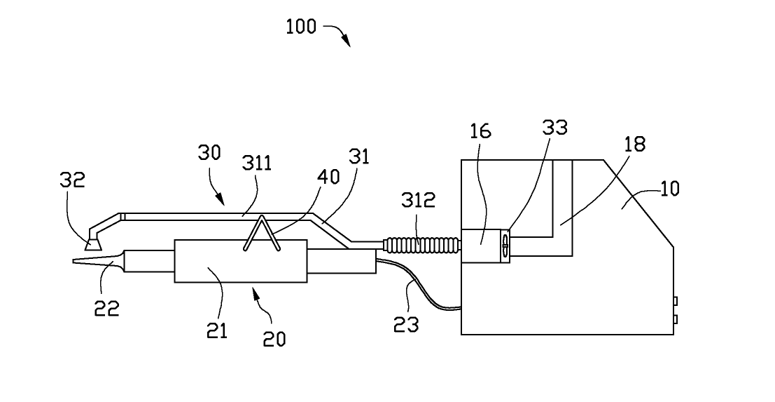

### BACKGROUND

1. Technical Field

The present disclosure relates to welding devices, and particularly to a welding device having a smoke exhaust function.

2. Description of Related Art

Welding processes may generate a great deal of harmful smoke and dust. Therefore, exhaust devices are often used in welding workshops to quickly remove the smoke and dust. However, typical exhaust devices are generally very large, heavy, and expensive. When welding devices are used in places where there are no exhaust devices installed, there is no easy way to remove the harmful smoke and dust from the work area, since the exhaust devices are too difficult to be carried and used with the welding devices outside of the workshops.

Therefore, there is room for improvement within the art.

### BRIEF DESCRIPTION OF THE DRAWINGS

Many aspects of the present disclosure can be better understood with reference to the following drawing. The components in the various drawings are not necessarily drawn to scale, the emphasis instead being placed upon clearly illustrating the principles of the present disclosure. Moreover, in the drawings, like reference numerals designate corresponding parts throughout the figure.

The FIGURE is a schematic view of a welding device, according to an exemplary embodiment.

### DETAILED DESCRIPTION

The FIGURE is a schematic view of a welding device 100, according to an exemplary embodiment. The welding device 100 includes a base unit 10, a welding gun unit 20, a smoke exhaust unit 30, and a holding unit 40. The welding gun unit 20 is structurally connected to the base unit 10. The smoke exhaust unit 30 is electrically connected to the base unit 10, and is fixed on the welding gun unit 20 with the holding unit 40.

The base unit 10 is substantially a closed box. Components of common welding devices (not shown), such as a switch, a power supply, and a welding rod supplying device, can be installed on/in the base unit 10. The base unit 10 further includes an inhalation chamber 16 and an exhaust pipe 18. The inhalation chamber 16 communicates with outside of the base unit 10 through the exhaust pipe 18.

The welding gun unit 20 includes a gun body 21, a welding head 22, and a cable 23. The welding head 22 is fixed on the gun body 21. The gun body 21 is electrically connected to a power supply (not shown) through the cable 23, and the power supply is installed in the base unit 10, such that the welding gun unit 20 can be turned on and off by operating the base unit 10. A heating device (not shown), such as a heating wire, is installed in the gun body 21, and is electrically connected to both the welding head 22 and the cable 23. When the power supply provides power to the heating device through the cable 23, the heating device can transform the power into heat, which heats the welding head 21 for welding. Furthermore, the cable 23 is flexible, which enables the welding gun unit 20 to be freely adjusted to desired operating positions relative to the base unit 10.

The smoke exhaust unit 30 includes a smoke pipe 31, a suction nozzle 32, and an exhaust driving device 33. The smoke pipe 31 includes a rigid first pipe 311 and a flexible second pipe 312. The first pipe 311 can be made of metal, and the second pipe 312 can be made of rubber. The first pipe 311 is structurally connected between the suction nozzle 32 and the second pipe 312, and the second pipe 312 is structurally connected between the first pipe 311 and the inhalation chamber 16, such that the suction nozzle 32 communicates with the inhalation chamber 16 through the smoke pipe 31. The flexibility of the second pipe 312 enables the position of the smoke exhaust unit 30 to be adjusted relative to the base unit 10. The suction nozzle 32 is funnel shaped, and is positioned adjacent to the welding head 22 for collecting smoke and dust generated by the welding head 22. In this embodiment, the first pipe 311 can be bent to desired shapes to increase the length of the first pipe 311, such that heat of smoke and dust passing through the first pipe 311 can be fully dissipated.

The exhaust driving device 33 is installed in the inhalation chamber 16 and is electrically connected to another power supply (not shown) installed in the base unit 10. The exhaust driving device 33 can be an exhaust fan or other typical exhaust driving devices. When the exhaust driving device 33 works, smoke and dust around the suction nozzle 32 (i.e., around the welding head 22) can be suctioned into the inhalation chamber 16 through the suction nozzle 32 and the smoke pipe 31, and thus can be exhausted via the exhaust pipe 18.

In this embodiment, the holding unit 40 is a substantially V-shaped holder. Two arms of the holding unit 40 are fixed on the gun body 21, and the V-shaped top end of the holding unit 40 is fixed on the smoke pipe 31. In this way, the smoke exhaust unit 30 and the welding gun unit 20 are fixedly assembled together, such that the suction nozzle 32 is stably positioned adjacent to the welding head 22, and the welding gun unit 20 and the smoke exhaust unit 30 can be moved in concert with each other. In other embodiments, the holding unit 40 can also be other shapes that are capable of fixedly assembling the smoke exhaust unit 30 and the welding gun unit 20 together.

In use, the power supply electrically connected to the gun body 21 is turned on and provides power to the heating device. The heating device transforms the power into heat which heats the welding head 21, and thus the welding head 21 can be used in welding operations according to common methods. At the same time, the power supply electrically connected to the exhaust driving device 33 is turned on to activate the exhaust driving device 33. During the welding operations, smoke and dust generated around the welding head 22 are suctioned into the inhalation chamber 16 through the suction nozzle 32 and the smoke pipe 31, and thus are exhausted via the exhaust pipe 18 to prevent pollution.

Furthermore, more exhaust driving devices (e.g., similar to the exhaust driving device 33) can be installed in the exhaust pipe 18 to enhance the power of suctioning and exhausting the smoke and dust generated in the welding operations. The exhaust pipe 18 can be connected to typical cleaning devices, such as an air purifier, to prevent the smoke and dust exhausted via the exhaust pipe 18 from polluting the environment.

In the present disclosure, the welding device 100 can suction and exhaust smoke and dust when it is used in welding operations. Compared with typical exhaust driving devices for removing smoke and dust during welding processes, the welding device 100 is much smaller, lighter, and cheaper.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A welding device, comprising:
a base unit;
a welding gun unit electrically connected to the base unit to be turned on and off by operations on the base unit; and
a smoke exhaust unit structurally connected to the base unit, the smoke exhaust unit including a smoke pipe, a suction nozzle, and an exhaust driving device, the smoke pipe connected to the base unit, the suction nozzle connected to the smoke pipe, and the exhaust driving device installed in the base unit; wherein the smoke exhaust unit suctions smoke and dust generated by use of the welding gun unit and exhausts the smoke and dust via the base unit.

2. The welding device as claimed in claim 1, wherein the base unit includes an inhalation chamber and an exhaust pipe, the inhalation chamber communicates with outside through the exhaust pipe, the smoke pipe communicates with the inhalation chamber, and the exhaust driving device is installed in the inhalation chamber.

3. The welding device as claimed in claim 2, wherein the exhaust pipe is connected to a cleaning device.

4. The welding device as claimed in claim 1, wherein the base unit supplies power to the exhaust driving device.

5. The welding device as claimed in claim 1, wherein the smoke pipe includes a rigid first pipe and a flexible second pipe, the first pipe is connected between the suction nozzle and the second pipe, and the second pipe is connected between the first pipe and the base unit.

6. The welding device as claimed in claim 5, wherein the first pipe is made of metal and bent to a predetermined shape.

7. The welding device as claimed in claim 5, wherein the welding gun unit includes a gun body, a welding head, and a cable; the welding head is mounted on the gun body, and the gun body is electrically connected to the base unit through the cable.

8. The welding device as claimed in claim 7, wherein the base unit provides power to the welding gun unit through the cable, and the welding gun unit transforms the power into heat which heats the welding head for welding.

9. The welding device as claimed in claim 8, wherein the cable is flexible.

10. The welding device as claimed in claim 9, further comprising a holding unit, wherein the smoke exhaust unit and the welding gun unit are fixedly assembled together by the holding unit.

11. The welding device as claimed in claim 10, wherein the suction nozzle is positioned adjacent to the welding head to suction the smoke and dust generated by use of the welding gun unit.

12. A welding device, comprising:
a base unit including an inhalation chamber and an exhaust pipe therein;
a welding gun unit electrically connected to the base unit; and
a smoke exhaust unit including a smoke pipe and an exhaust driving device; the smoke pipe connected to the inhalation chamber, and the exhaust driving device installed in the inhalation chamber;
wherein smoke and dust generated by use of the welding gun unit passes through the smoke pipe to enter the inhalation chamber, and the exhaust driving device exhausts the smoke and dust through the exhaust pipe.
